(19) United States
(12) Patent Application Publication
(10) Pub. No.: US 2007/0269163 A1
(43) Pub. Date: Nov. 22, 2007

(54) Apparatus for Equalizing a Spectrum of a Broadband Light Source

(76) Inventors: Pieter Lodewikus Swart, Roodepoort (ZA); Thbiso James Nhlapo, Brakpan (ZA); Anatoli Aleksandrovich Chtcherbrakov, Johannesburg (ZA)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/561,508

(22) PCT Filed: Jun. 21, 2004
(86) PCT No.: PCT/IB04/50947

§ 371 Date: Jan. 31, 2007

(30) Foreign Application Priority Data
Jun. 30, 2003 (ZA) 2003/4813

(51) Int. Cl. G02F 1/225

(52) U.S. Cl. 385/37

(57) ABSTRACT

The invention relates to an apparatus suitable for equalizing a spectrum of a broadband light source comprising a first optical path and a second optical path; an optical splatter being connectable to an optical power source, for directing at least part of optical power from the optical power source to each of the first and second optical paths; an optical filter provided in the first optical path for filtering the optical signal propagating there through; and an optical combiner for combining at least part of the optical signals from each of the first and second paths into an output channel. Preferably, the optical splitter is tuneable to direct at least part of the optical power from the optical source to each of the first and second paths, in varying proportions.

### FIELD OF THE INVENTION

This invention relates to an apparatus for equalising a spectrum of a broadband light source. More particularly, but not exclusively, the invention relates to an apparatus for dynamically equalising the spectrum of an Amplified Spontaneous Emission (ASE) source such as an Erbium-doped fibre.

### BACKGROUND TO THE INVENTION

Broadband light sources in the 1520 nm to 1560 nm spectral range find application in fibre Bragg grating sensors and optical communication systems, where optical amplifiers are regularly employed to compensate for optical power loss.

Super-luminescent ASE sources having amplified spontaneous emission from erbium-doped fibre that is pumped at either 1480 nm or 980 nm, makes them favored candidates for these applications. The output power of these sources, however, varies considerably for different wavelengths and a marked peak is apparent near 1530 nm on a power spectrum of the light source. The amplitude of this peak is also dependent on the power level of the pump laser.

The gain spectrum of an optical amplifier is seldom uniform and a gain equalizer is required to equalize the gain. Apparatus designed to flatten the gain of an Erbium Doped Fibre Amplifier (EDFA) over a wide spectral range for large capacity Wavelength-Division-Multiplexed (WDM) optical communication systems, are well known in the art.

One such gain flattening apparatus incorporates an optical filter within the length of an EDFA¹. The optical filter is a notch filter based on the resonant coupling between core propagating mode and cladding leaky mode. By way of example, when tuned to suppress the gain spectrum at the peak wavelength, a broadband amplifier with a 3 dB bandwidth of 33 nm, a gain of 27 dB and uniform saturation characteristics is obtained.

As the pump current of an ASE source is varied to set the output power to a required value, the spectral shape of the ASE source changes. Some known prior art equalisers provide for the attenuation of the filter to be increased or decreased in accordance with the pump current, or other criteria.

For example, one such known apparatus comprises a three Guassian shaped passive filters which produce a substantially flat gain over a 30 nm-wavelength range². In this apparatus, an active filter which can produce six different sine-function type notch profiles with variable centre wavelengths and rejection ratios was used as a mid-stage gain flattening device in a dual stage EDFA. The gain-flattening filter consists of two all-fibre acoustooptic tuneable filters (AOTF) in series. Each AOTF was driven by three radio frequency signals and different frequencies and amplitudes to produce acoustooptic mode conversion from the fundamental mode to different cladding modes. By adjusting the filters' spectral profiles electronically, a gain flatness of <0.7 dB over 35-nm wavelength range at various levels of gain as well as input signal and pump power, was achieved using the apparatus.

Another known gain-flattening apparatus uses multiple photosensitive side-tap Bragg gratings to equalise the gain spectrum of EDFA's to within +/−0.3 dB over 33 nm with a 0.3 dB loss penalty³. Different shaped filters may be made by choosing a suitable peak loss wavelength for each grating.

Yet another known apparatus comprises an interleaver using a wavelength dependent birefringence crystal, which has a variable optical path length⁴. A light from an input port is separated in a polarisation beam splitter. One of them is rotated by 90 degrees by a half wave plate and they become same direction of polarisaton. A polarisation rotator rotates the direction of polarisation of the light to vary an incident polarisation angle from a crystal axis of an optical path length variable birefringence crystal in order to vary transmittance at a particular wavelength. The optical path length of the crystal can be varied by adjusting the thickness of the crystal.

Other known dynamic equalisers comprise two-stage amplifiers having two doped-fibre compositions so that each stage has a different gain spectrum⁵. Gain equalisation is achieved by separately pumping the two amplifier stages to control the overall gain spectrum in order to equalise the output levels of the amplified channels. When used under automatic control, the amplifier gain could be equalised dynamically to compensate random variations in the relative optical power of wavelength-multiplexed signals.

In another prior art apparatus gain equalisation and constant power output are achieved by changing the laser diode pump power and attenuation of a voltage controlled attenuator dynamically⁶.

Disadvantages of known dynamic gain equalisers are that they are complex to configure and implement; and they are costly to manufacture.

### OBJECT OF THE INVENTION

It is an object of this invention to provide an apparatus for equalising a spectrum of a broadband light source that at least partially alleviates the difficulties associated with prior art equalisers and provides a useful alternative to known equalising apparatus. More particularly, an object of the present invention is to provide a useful alternative to known prior art for equalising a gain spectrum of an EDFA.

### SUMMARY OF THE INVENTION

According to the invention there is provided an apparatus suitable for equalising a spectrum of a broadband light source comprising a first optical path and a second optical path; an optical splitter being connectable to an optical power source, for directing at least part of the optical power from the optical power source to each of the first and second optical paths; an optical filter provided in the first optical path for filtering the optical signal propagating there through; and an optical combiner for combining at least part of the optical signals from each of the first and second paths into an output channel.

In a preferred form of the invention the optical splitter is tuneable to direct at least part of the optical power from the optical power source to each of the first and second paths, in varying proportions.

In another embodiment of the Invention, an adjustable gain amplifier is provided in the second optical path to amplify/attenuate to a varying degree, the optical signal propagating there through.

In this embodiment, the adjustable gain amplifier may have a gain of greater than 1 or less than 1, where a gain less than 1 attenuates the optical signal propagating through the second path and a gain of greater than 1 amplifies the optical signal propagating through the second path,

The optical combiner may be a 3 dB coupler for directing half the optical power from the first path and half the optical power from the second path into the output channel. It is envisaged that an equalised power spectrum of the optical power source will be measurable at the output channel.

The filter may be a Long Period Grating (LPG). Preferably, the filter has an attenuation band corresponding to a range of wavelengths at which the peak or peaks in the spectrum of the optical power source occur, such that the filter acts as a notch filter or a band stop filter.

In one embodiment of the invention the first and second paths are two arms of a Mach-Zehnder interferometer (MZI).

It is envisaged that the apparatus will be sufficiently tuneable to enable an input signal to be attenuated or amplified by at least 10 dB (measured at the output channel).

The optical power source may be an Erbium Doped Fibre Amplifier.

### BRIEF DESCRIPTION OF THE DRAWINGS

An apparatus for spectral equalisation of amplified spontaneous emission sources according to the invention is described below by way of a non-limiting example only and with reference to the accompanying figures, in which:

FIG. 1 shows a schematic diagram of an apparatus according to the invention, including a tuneable optical splitter;

FIG. 2 shows a schematic diagram of the apparatus of FIG. 1, in use in an experimental set-up of an optical amplifier;

FIG. 3 shows a plot of the theoretical transfer function of the apparatus of FIG. 1 for a range of coupling ratios K, of the tuneable optical splitter;

FIG. 4 shows a plot of experimentally determined relative attenuation spectra for various values of coupling ratio using a tuneable optical splitter;

FIG. 5 shows a plot in dotted line of an amplified spontaneous emission spectrum (without equalisation of the spectrum) as well as a plot in solid line of an equalised amplified spontaneous emission spectrum of an Erbium Doped Fibre source, having a 150 mA pump current;

FIG. 6 shows a plot in dotted line of an amplified spontaneous emission spectrum (without equalisation of the spectrum) as well as a plot in solid line of an equalised amplified spontaneous emission spectrum of an Erbium Doped Fibre source, having a 180 mA pump current; and

FIG. 7 shows a plot in solid line of the non-equalised gain of the EDFA, and in dotted line of the equalised gain, of the apparatus shown in FIG. 2.

### DESCRIPTION OF PREFERRED EMBODIMENT

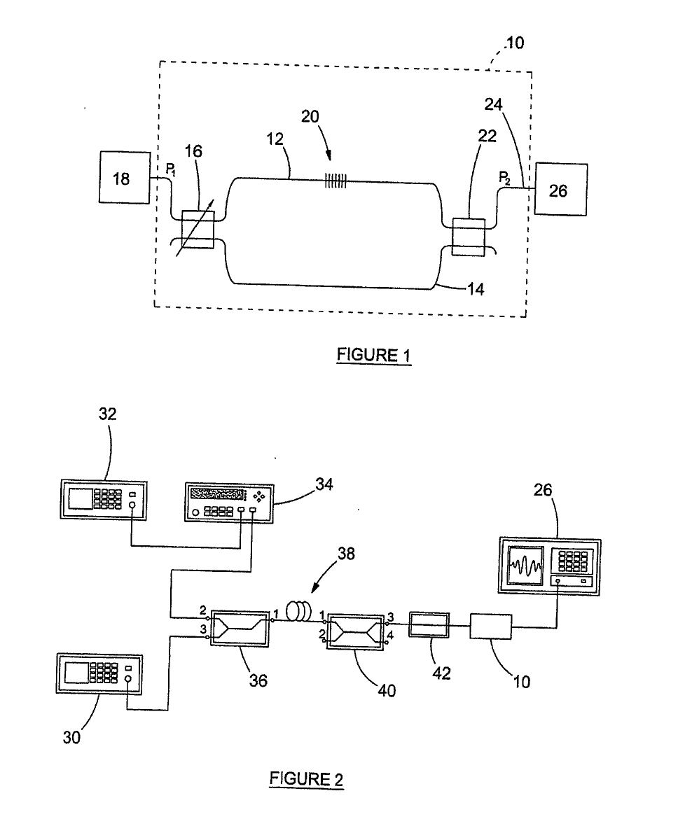

A schematic representation of a preferred embodiment of the apparatus according to the invention is shown in FIG. 1.

The apparatus 10 consists of a first optical path 12 and a second optical path 14; an optical splitter in the form of a tuneable optical coupler 16; a filter provided in the form of a non-tuneable Long Period Grating (LPG) 20; and an optical combiner in the form of 3 dB fixed optical coupler 22 for directing half of the optical signals from each of the first and second paths 12, 14 into an output channel 24.

The tuneable optical coupler 16 is connectable to an Amplified Spontaneous Emission (ASE) source 18, for directing optical power from the ASE source 18 to each of the first and second optical paths 12, 14 in a variable proportion.

The LPG 20 is provided In the first optical path 12 for filtering the optical signal propagating there through. An equalised power spectrum of the ASE source 18 is measurable at the output channel 24 with an optical spectrum analyser 26.

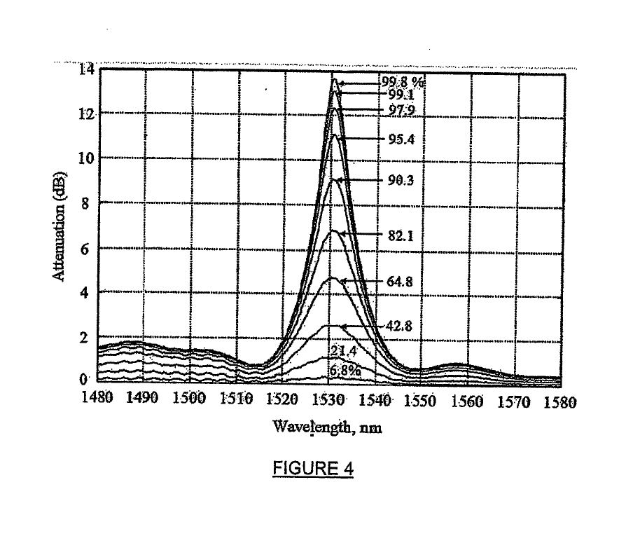

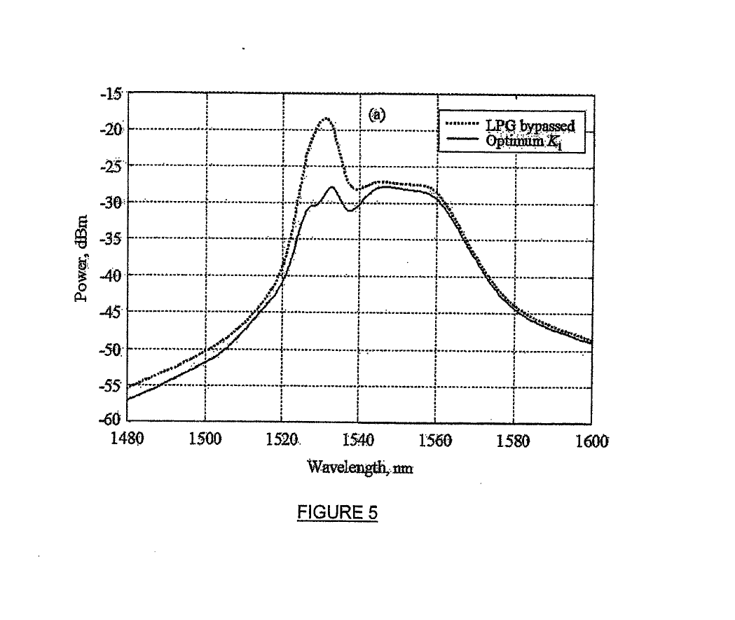

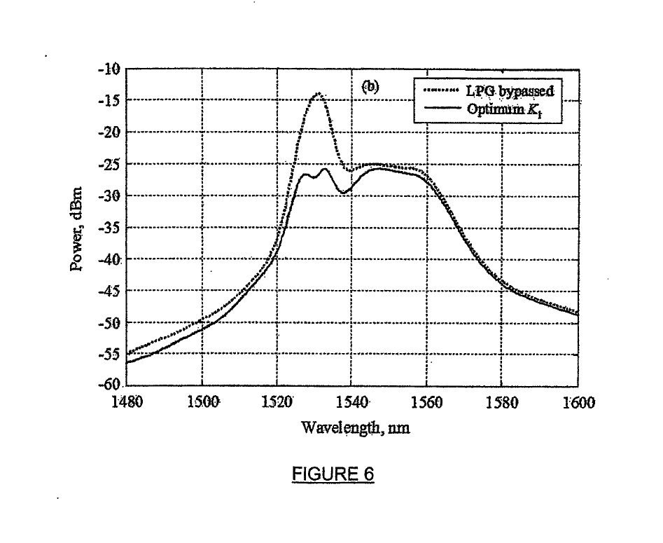

The LPG has an attenuation band corresponding to a range of wavelengths at which the peak in the spectrum of the optical power source occurs, such that the LPG acts as a notch filter or a band stop filter. FIGS. 3 and 4 show that the LPG 20 has an attenuation band at a set of wavelengths in the range 1500 nm-1600 nm. In this particular embodiment, the LPG 20 has only a single attenuation peak at 1531 nm. This corresponds to the peak in the spectrum of the ASE source, apparent from the spectrums shown in FIGS. 5 and 6.

The required maximum attenuation and the bandwidth of the LPG 20 are achieved by a proper choice of the length, period and refractive index excursion during the design and manufacturing stage of the LPG 20.

It is further apparent that the invention comprises a Mach-Zehnder interferometer having the LPG 20 provided in one arm thereof, the two arms of the Mach-Zehnder interferometer corresponding with the first and second paths 12, 14. The tuneability of the apparatus arises by incorporating the LPG 20 in a Mach-Zehnder configuration that includes the tuneable optical coupler 16.

By increasing the coupling ratio K₁ of the tuneable coupler 16, the ratio of the optical power directed from the input signal to each of the first and second paths 12, 14 changes. If the coupling ratio K₁ of the tuneable coupler 16 is adjusted between 0% and 100%, an optical signal of an increasing power will propagate through the first path and hence also the LPG 20, causing an increasingly larger attenuation of the peak in the power spectrum of the source 18 measurable at the output channel 24.

The fixed coupler 22 combines the signals propagating through the first and second paths 12, 14. If the coherence length of the ASE source 18 is short, interference effects are negligible. It can be assumed that both the tuneable and fixed couplers 16, 22 are lossless. Under these assumptions, the power transfer function of the apparatus between ports P₁ and P₂ is:

$$T ( O ) ( \begin{matrix}1 & {K}_{2}\end{matrix} ) {K}_{1} \frac{{K}_{2}}{{K}_{2}} {T}_{co} ( O ) 1 \qquad ( 1 )$$

where K₁ is the power coupling ratio of the tuneable coupler 16. It is assumed that the tuneable coupler 16 is tuneable between 0% and 100% meaning that the tuneable coupler can be tuned to direct 0% of the input signal to the first path and 100% of the input signal to the second path or 100% of the input signal to the first path and 0% of the input signal to the second path. K₂ is the power-coupling ratio of the fixed coupler 22. In this embodiment this is 0.5 (as the fixed coupler 22 is a 3 dB coupler). T_{∞}(O) is the transmission spectrum of the LPG 20 for core-to-core propagation and is given by the following expression⁷⁻⁹

$${T}_{co} ( O ) {cos}^{2} ( ϑ L ) \frac{{Γ}^{2}}{{ϑ}^{2}} {sin}^{2} ( ϑ L ) , \qquad ( 2 )$$

where L is the length and / is the period of the LPG 20, Λ is the coupling coefficient,

$$Γ \sum / l \frac{C {C}_{0}}{O}$$

is the normalized frequency which indicates the deviation from synchronism, and [symbol] N² Γ^{2 1/2}.

FIG. 3 illustrates the calculated relative attenuation as a function of wavelength for various values of the coupling ratio K₁ of the tuneable optical coupler 16. Because a 3 dB coupler 22 is used at the output channel 24, the apparatus 10 has an insertion loss of 3 dB.

In this embodiment, a change in attenuation of approximately 14 dB in a wavelength band centered at 1531 nm Is achieved. This makes the apparatus 10 ideally suitable for equalization of the output power spectrum of erbium-doped fibre super-luminescent sources. In an experimental demonstration of this application, the power spectral density variation of the source improved from ρ 4.8 dB to ρ 1.58 dB in the wavelength range from 1524 nm to 1563 nm.

FIG. 4 shows the measured relative transmittance of the apparatus over the wavelength range 1480 nm to 1580 nm as obtained with a broadband optical source (super-luminescent light-emitting diode) and an optical spectrum analyzer 26 in an experimental set-up similar to FIG. 1. The ASE source 18 comprised of 16 m erbium-doped fiber and a 980 nm pump laser with maximum output power of 80 mW.

FIG. 5 depicts the recorded spectra for a pump current of 150 mA and FIG. 6 depicts the recorded spectra for a pump current of 180 mA. The coupling ratio K₁ of the tuneable optical coupler 16 is adjusted either to bypass the LPG 20 completely (dotted lines), or to effect the optimum attenuation value for each of the pump currents respectively. This illustrates the effectiveness of the apparatus to suppress the peak in the power spectral density of the ASE source 18 around 1530 nm.

The experimentally determined characteristics of the apparatus correspond very well with the calculated values as can be seen by comparing FIG. 3 with FIG. 4. During experimentation, the apparatus was capable of being tuned between approximately 0 dB and 14 dB at 1530 nm. It is possible to expand this range by employing an LPG 20 with larger coupling from the core mode to the cladding mode of interest.

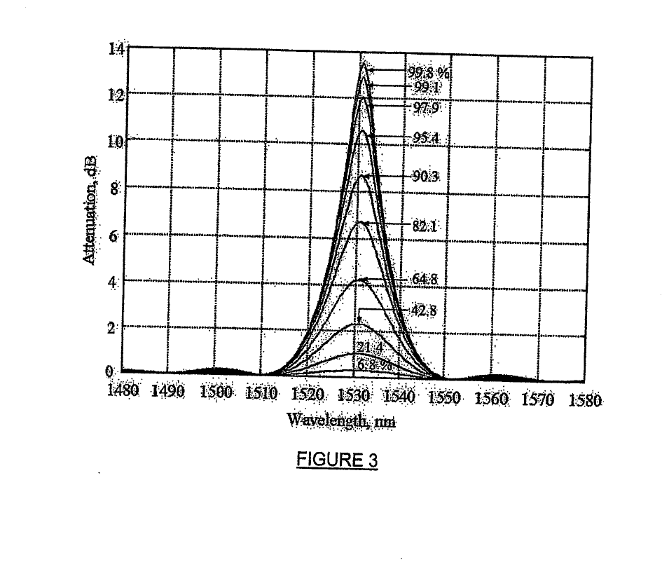

FIG. 2 shows the apparatus used in an experimental set-up intended to demonstrate its use in an optical communications network. In this set-up, the ASE source 18 is used as an Erbium Doped Fibre Amplifier (EDFA) for amplifying communication signals transmitted across an optical network. The EDFA is comprised of a 16 m long erbium doped fibre 38, a first Wavelength-Division-Multiplexed (WDM) coupler 36; a second WDM coupler 40 and an optical isolator 42 for blocking reflected light from the apparatus 10. The EDFA is co-directionally pumped at 980 nm using a 980 nm laser diode 30.

An optical communication signal is created using a tuneable laser source 32 and a variable attenuator 34 and the communication signal is directed into the first WDM coupler 36. The second WDM coupler 40 is used to dump the residual pump power while allowing the 1550 nm signal to propagate through the second WDM coupler 40.

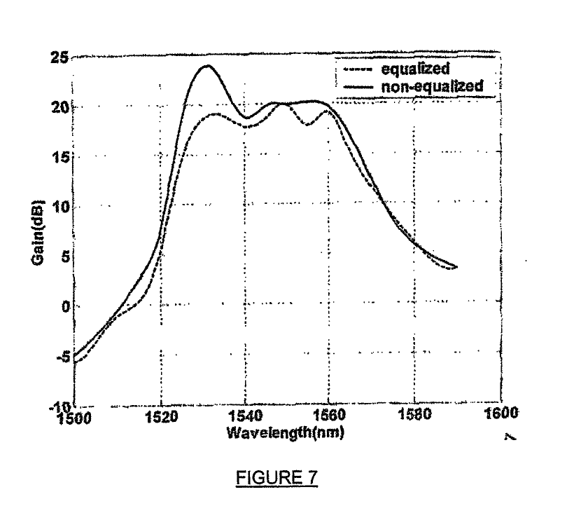

An equalised gain spectrum of the EDFA was achieved by adjusting the first tuneable coupler 16 appropriately. The EDFA was pumped at a current of 150 mA and the signal input power of −30 dBm wavelength tuneable range was used as the input power to the EDFA. The measured gain of the EDFA is shown in FIG. 7. It can be seen from FIG. 7 that the apparatus 10 improves the gain flatness of the EDFA.

It is envisaged that when using the apparatus 10 as a spectral equalizer for an ASE source, the ripple in the source spectrum could be reduced from ρ 4.8 dB and ρ 1.58 dB at a pump laser current of 150 nA and from ρ 6.1 dB to ρ 1.9 dB at a pump laser current of 180 mA. Similar performance was achieved at other pump currents by adjusting the tuneable coupler 16 appropriately. These values may be improved by using a cascade of normal and phase-shifted LPGs as suggested by Zhu et al.¹⁰

Although a manual system is described, it is envisaged that an electronically controlled tuneable coupler 16 incorporated in a closed-loop controller would be ideal for dynamically adjusting the attenuation of the apparatus 10.

The invention is not limited to the precise details as described above. For example, the concept may be implemented in integrated optics as opposed to fibre optics; heating element may be used to tune the tuneable coupler; and the optical splitter may be a fixed coupler and an adjustable gain amplifier may be provided In the second path to amplify (with gain greater than or less than 1) to a variable degree, the signal propagating there through.

Tuneability of the apparatus assures that spectral ripple can be controlled over wide range of pump power. It is envisaged that as the pump current Is varied to set the output power to the required value, the attenuation of the apparatus 10 measured at the output channel can be adjusted. For an ASE source 18 with a 15 dB range in output power, it was found experimentally that the peak in the spectrum at 1530 nm varies by more than 10 dB. It is envisaged therefore that the apparatus would be tuneable to adjust the attenuation of the LPG 20 by at least 10 dB.

### REFERENCES

1. M. Tachibana, R. I. Laming, P. R. Morkel and D. N Payne, “Erbium-Doped Fiber Amplifier with Flattened Gain Spectrum”, IEEE Photonics Technology letters 3(2) 118-119 (1991).
2. Hyo Sang Kim, Seok Hyun Yun, Hyang Kyun Kim, Namkyoo Park and Byoung Yoon Kim, “Actively Gain-Flattened Erbium-Doped Fiber Amplifier Over 35 nm by using All-Fiber Acoustooptic Tunable Filters”, IEEE Photonics Technology letters 10(6), 790-794 (1998).
3. R. Kashap, R. Wyatt, P. F. McKee “Wavelength Flattened Saturated Erbium Amplifier Using Multiple Side-tap Bragg Gratings” Electronics Letters, Vol 29. No 11, (1993)
4. M. Shigehara, T. Kenmochi, T. Sano and H. Suganuma, “Variable Attenuation and Wavelength Filter”, Sumitomo Electric Industries, Ltd.
5. C. R. Giles and D. J. Di Giovanni, “Dynamic Gain Equalization in Two-Stage Fiber Amplifiers”, IEEE Photonics Technology letters 2(12), 866-868 (1990).
6. Seo Yeon Park, Hyang Kyun Kim, Gap Yeol Lyu, Sun Mo Kang and Sang-Yung Shin, “Dynamic gain and Output Power Control in a Gain-Flattened Erbium-Doped Fiber Amplifier,” IEEE Photonics Technology letters 10(6), 787-789 (1998).
7. A. M. Vengsarkar, P. J. Lemaire, J. B. Judkins, V. Bhatia, T. Erdogan and J. E. Sipe, “Long-period fiber gratings as band-rejection filters,” J. Lightwave Technol., 14(1), 58-65 (1996).
8. H. Kogelnik, “Theory of optical waveguides,” in Guided-Wave Optoelectronics, 2^{nd} Ed., T. Tamir, Ed., Springer-Verlag, New York, 7-88 (1990).
9. T. Erdogan, “Fiber grating spectra,” J. Lightwave Technol., 15(8), 1277-1294 (1997).
10.Y. Zhu, B. M. Lacquet, P. L. Swart, S. J. Spammer, P. Shum and C. Lu, “Device for concatenation of phase-shifted long-period grating and its application as gain-flattening fiber filter,” Opt. Eng., 42(5), 1445-1450 (2003).

1. An apparatus suitable for equalizing a spectrum of a broadband light source comprising:
a first optical path and a second optical path;
an optical splitter being connectable to an optical power source, for directing at least part of optical power from the optical power source to each of the first and second optical paths;
an optical filter provided in the first optical path for filtering the optical signal propagating there through; and
an optical combiner for combining at least part of the optical signals from each of the first and second paths into an output channel.

2. An apparatus as claimed in claim 1 wherein the optical splitter is tuneable to direct at least part of the optical power from the optical source to each of the first and second paths, in varying proportions.

3. An apparatus as claimed in claim 1 wherein an adjustable gain amplifier is provided in the second optical path to amplify to a varying degree, the optical signal propagating there through.

4. An apparatus as claimed in claim 3 wherein the adjustable gain amplifier has a gain of greater than or less than 1, where a gain less than 1 attenuates the optical signal propagating through the second path and a gain of greater than 1 amplifies the optical signal propagating through the second path.

5. An apparatus as claimed in claim 1 wherein the optical combiner is a 3 dB fixed optical coupler for directing half the optical power from the first path and half the optical power from the second path into the output channel.

6. An apparatus as claimed in claim 1 wherein the optical filter is a Long Period Grating (LPG).

7. An apparatus as claimed in claim 1 wherein the optical filter has an attenuation band corresponding to a range of wavelengths at which a peak in the spectrum of the optical power source occurs, such that the optical filter acts as a notch filter or a band stop filter.

8. An apparatus as claimed in claim 1 wherein the first and second paths are two arms of a Mach-Zehnder interferometer (MZI).

9. An apparatus as claimed in claim 1 wherein the apparatus is sufficiently tuneable to enable an input signal to be attenuated or amplified by at least 10 dB (measured at the output channel).

10. An apparatus as claimed in claim 1 wherein the optical power source is an Amplified Spontaneous Emission (ASK) source.
